(19) United States
(12) Patent Application Publication
(10) Pub. No.: US 2021/0298235 A1
(43) Pub. Date: Sep. 30, 2021

(54) SELF-PROPELLING COMBINE AND METHOD FOR OPERATING A SELF-PROPELLING COMBINE

(71) Applicant: CLAAS Selbstfahrende Erntemaschinen GmbH, Harsewinkel (DE)

(72) Inventors: Christian Beulke, Echte (DE); Matthias Heinze, Bielefeld (DE); Christopher Vieregge, Dörentrup (DE)

(73) Assignee: CLAAS Selbstfahrende Erntemaschinen GmbH, Harsewinkel (DE)

(21) Appl. No.: 17/190,534

(22) Filed: Mar. 3, 2021

(30) Foreign Application Priority Data
Mar. 24, 2020 (DE) 102020108083.2

(51) Int. Cl. A01D 41/12; A01F 12/44

(52) U.S. Cl. CPC A01D 41/1243; A01F 12/44

(57) ABSTRACT

A self-propelling combine and a method for operating a self-propelling combine are disclosed. The combine includes a straw chopper for processing a residual flow formed by plant residues, a cleaning device for cleaning a flow of material formed primarily by grains from residual components contained therein, a chaff spreader, and a power spreader. Using the chaff spreader, the residual components separated from the flow of material by the cleaning device are removed. Further, the residual flow, processed using the straw chopper, is ejected using the power spreader. For improved distribution of unutilized plant residues on the field, the power spreader is assigned to the straw chopper at the bottom such that the residual flow leaving the straw chopper is transferred directly to a material inlet region of the power spreader, and the residual components leaving the chaff spreader are emitted into a transfer region upstream from the power spreader.

### CROSS REFERENCE TO RELATED APPLICATION

This application claims priority under 35 U.S.C. § 119 to German Patent Application No. DE 102020108083.2 filed Mar. 24, 2020, the entire disclosure of which is hereby incorporated by reference herein.

### TECHNICAL FIELD

The present application relates to a method for operating a self-propelling combine and to a self-propelling combine.

### BACKGROUND

Residual flow formed by plant residues may be processed using a straw chopper of the combine. The residual flow may be formed beforehand using a separating device of the combine. The separating device may include a separating rotor or a straw walker into which a flow of material may be fed thereto. The flow of material may primarily comprise grain, with a residual portion of the flow comprising the plant residue. In this regard, the separating device may separate the grain from the plant residue. In turn, the grain, separated from the residual components, may be cleaned using a cleaning device. In particular, the cleaning device may clean the grain in order to produce, for example, chaff, short stalks, and loss grain, which the cleaning device may send to a chaff spreader (such as a power spreader), which is downstream of the cleaning device. The chaff spreader may, for example, comprise at least one throw blower through which the residual components are blown out in a rearward direction of the combine.

Downstream from the straw chopper is a power spreader through which the residual flow that was processed and conveyed using the straw chopper is received and then ejected from the combine. Moreover, the power spreader is generally downstream from the chaff spreader in terms of flow so that the residual components emitted by the chaff spreader is received by the power spreader and then ejected together with the residual flow. The power spreader may comprise a plurality of ejection units, such as two ejection units arranged or positioned next to each other.

An example combine harvester is disclosed in U.S. Pat. No. 10,362,732, incorporated by reference herein in its entirety. U.S. Pat. No. 10,362,732 describes a method to transfer the residual components using the chaff spreader to the power spreader. The residual components are then ejected from the combine together with the residual flow using the power spreader. For this purpose, the residual components are fed to a front region of the power spreader in the driving direction of the combine, wherein an opening is in the front region of the housing of the power spreader through which the residual components may enter into the power spreader. Within the power spreader, the residual flow received by the straw chopper is mixed with the residual components fed to the power spreader, and both are ejected from the combine together at a rear end of the power spreader.

### DESCRIPTION OF THE FIGURES

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1 illustrates a cross-section of a combine.

FIG. 2 illustrates a schematic view of a chaff spreader interacting with a straw chopper and a power spreader.

FIG. 3 is similar to the illustration in FIG. 2 but from a different perspective.

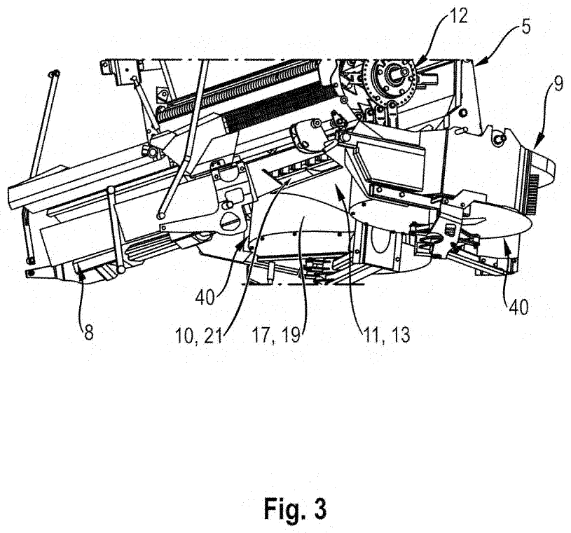

FIG. 4 is a perspective view of the straw chopper according to FIG. 2 with a downstream power spreader.

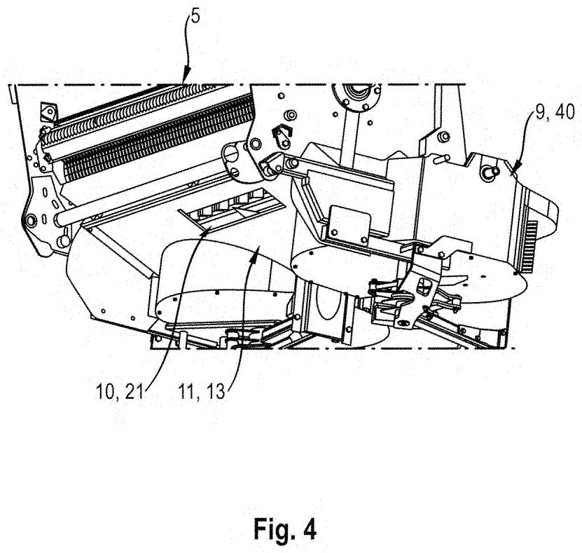

FIG. 5 is similar to the illustration in FIG. 2, but in a side cross-section.

FIG. 6 is a schematic cross-section of a straw chopper of a combine according to one embodiment.

FIG. 7 illustrates detail of a floor region of the housing according to the illustration in FIG. 2.

### DETAILED DESCRIPTION

As discussed in the background, various residual components are transferred to the power spreader. However, the transfer of the residual components to the power spreader may not always occur in a satisfactory manner. In particular, eddies may arise at the opening in the power spreader so that the residual components that are “enclosed” in the opening cannot enter and instead fall to the floor before they enter into the power spreader. This is disadvantageous when it is sought to deposit the residual components evenly or homogeneously on the field. Instead, the residual components are deposited, to a greater extent, directly in a trail immediately following the combine since the distribution in a lateral direction relative to combine, that is otherwise accomplished by the power spreader, does not happen.

Thus, in one or some embodiments, a method and a combine are disclosed through which improved distribution of unutilized plant residue on the field is achieved.

In one or some embodiments, a method and apparatus are disclosed for operating a self-propelling combine. The method and apparatus include the power spreader being assigned to the straw chopper at the bottom such that the residual flow leaving the straw chopper is transferred directly to a material inlet region of the power spreader, and the residual components leaving the chaff spreader are emitted into a transfer region upstream from the power spreader. Accordingly, proceeding from the chaff spreader, the residual components are added to the residual flow at least partially upstream from the at least one power spreader. In this manner, the residual flow and the residual components are transferred jointly to the material inlet region of the power spreader. In other words, in contrast to the prior art, the mixing of the residual flow and residual components does not first occur in the power spreader, but rather already upstream from the power spreader so that at the moment in which the residual components and residual flow are received by the power spreader, they are already mixed.

The method and apparatus may have one or more advantages. For example, guidance of the residual components to the residual flow occurs in a region that, in comparison to the prior art, has a lower susceptibility to restrictive flow conditions that could prevent the entrance of the residual components and their mixture with the residual flow. As described above, this may occur in the prior art, wherein the transfer of the residual components to a front region of the power spreader undertaken at that location also has a similar susceptibility to unfavorable flow conditions so that the residual components are restrained and can fall before entrance into the power spreader. By already supplying, according to one or some embodiments, the residual components upstream from the power spreader, a direct transfer to the power spreader is avoided in order to reduce the possibility of the above-described potentially unfavorable flow conditions, and to ensure a reliable entrance of the residual components into the power spreader (e.g., in the form mixed with the residual flow).

In one or some embodiments, the residual components are fed to the straw chopper, such as downstream from a chopping unit of the straw chopper. In one or some embodiments, the straw chopper is located upstream (such as directly upstream) from the power spreader. Feeding of the residual components to the straw chopper has the advantage that the chopping unit may act at least indirectly on the residual components so that their mixture with the residual flow is improved. In this manner, a mixed flow formed by mixing the residual components and the residual flow may be homogenized.

In one or some embodiments, the residual components pass through an opening arranged in a floor of the straw chopper into the transfer region. The floor, and therefore the transfer region as well, may be connected directly to the material inlet region of the at least one power spreader. Transferring the residual components in the region of the floor of the straw chopper prevents the residual components from being processed by the straw chopper together with the residual flow, which in any event is unnecessary given the already small particle size of the residual components. Feeding the residual components in the region of the floor of the straw chopper is nonetheless generally sufficient to ensure a mixture thereof with the residual flow before the residual flow and the residual components jointly enter the material inlet region of the power spreader.

Independent of whether or not the chaff spreader comprises one or more throw blowers (the latter is typically the case), it may be advantageous if one, some or all of the throw blowers emit the residual components into the same transfer region. In this manner, the residual components may be mixed quite efficiently with the residual flow. The transfer may occur through an opening (such as a common opening) in the floor of the straw chopper.

In order to facilitate the entry of the residual components into the straw chopper, it may be particularly advantageous if the residual flow passing through the straw chopper is deflected (e.g., redirected) in the transfer region. This may be performed, for example, using a guide element, such as a guide plate, that changes the flow direction of the residual flow. The effect of the deflection is that an entry volume is created in the transfer region, which is available for the residual components for entry into the transfer region. In this manner, the residual components may have sufficient room available to reliably enter into the transfer region even when the straw chopper has a very high load comprising (or consisting of) a correspondingly large volumetric flow of the residual flow.

Proceeding from the transfer region, the residual flow and the residual components mixed therewith may be transferred directly to the material inlet region of the power spreader. In this case, it may be advantageous if the power spreader is assigned to the bottom side of the straw chopper such that the delivery direction of the residual flow as well as the residual components is oriented obliquely downward when they are transferred to the material inlet region. In one or some embodiments, the delivery direction may be oriented obliquely relative to the horizontal within a range between 15° and 65° (e.g., at least 15° and/or at most 65°), more particularly between 20° and 40° (e.g., at least 20° and/or at most 40°), and even more particularly between 25° and 35° (e.g., at least 25° and/or at most 35°). The delivery direction of the residual components and the residual flow, which is thereby oblique in comparison to the at least substantially horizontal delivery direction of the residual flow at the moment of acceptance by the power spreader as is known in the prior art, has the advantage that the operation of the power spreader may disturb the flow of the residual flow and the residual components less than is the case in the prior art.

The power spreader may have a plurality of delivery blades that rotate about a vertical axis of rotation. Using the arrangement described above, the volumetric flow comprising (or consisting of) the residual flow and residual components are fed to the power spreader more or less (such as substantially) “obliquely from above” in comparison to feeding “from the rear” according to the prior art. This makes it possible to close a housing of the power spreader at a front region—viewed in the direction of driving the combine—which may prevent the unintended discharge of individual parts of the mixed flow from the power spreader in the front region. Also, with such a design, the power spreader is housed so that the residual components conveyed by the chaff spreader cannot enter directly into the power spreader but must instead travel the detour through the transfer region. This may ensure that the residual flow and the residual components are only ejected by the power spreader at a rear region or back end of the power spreader as is also desired, and not unintentionally at the front end of the power spreader.

Moreover, such a method and an apparatus may be advantageous in which a delivery direction of the residual components deflects their entry into the transfer region, namely to a delivery direction of the residual flow. In other words, the residual components are accordingly more or less assimilated by the residual flow, wherein the residual flow continues its flow at least substantially, such as completely, unhindered by the entry of the residual components, however jointly with the latter after adding the residual components. The delivery direction of the residual components may be correspondingly changed and deflected.

In one or some embodiments, the delivery direction of the residual components is oriented obliquely upward within a range of between 5° and 45° (e.g., at least 5° and/or at most 45°), more particularly between 10° and 40° (e.g., at least 10° and/or at most 40°), relative to the horizontal before being added to the residual flow. In the prior art, the residual components are in contrast ejected to the rear at least substantially in a horizontal direction using the particular chaff spreader. The ejection of the residual components in an obliquely upward direction which differs therefrom contrastingly offers the advantage that the residual components can be “shot into” the residual flow above the power spreader in terms of height, wherein the power spreader can, in particular, be at the level of the chaff spreader in terms of height. Feeding the residual components into the transfer region, which may be arranged upstream from the power spreader, may therefore be easy to implement by using the delivery direction of the residual components angled obliquely upward, wherein an entry into a straw chopper positioned above the power spreader in terms of height is contemplated.

Thus, in one or some embodiments, a self-propelling combine is disclosed. The combine includes: a straw chopper for processing a residual flow formed by plant residues; a cleaning device for cleaning a flow of material formed primarily by grains from residual components contained therein; a chaff spreader; and a power spreader, wherein using the chaff spreader, the residual components (separated from the flow of material using the cleaning device) can be removed, wherein the power spreader has a material inlet region into which the residual flow processed using the straw chopper can be transferred proceeding from a transfer region, and wherein the residual flow can be ejected from the combine using the power spreader. The combine may further include the power spreader being assigned to the straw chopper at the bottom such that the residual flow leaving the straw chopper can be transferred directly to a material inlet region of the power spreader, and the residual components leaving the chaff spreader can be emitted at a transfer region upstream from the power spreader. In particular, the combine may have at least one opening upstream from the at least one power spreader through which the residual components conveyed by the at least one chaff spreader can be discharged into the transfer region. Subsequently, the residual flow and the residual components, which can be mixed with each other in the transfer region, may be transferred jointly directly to the material inlet region of the power spreader downstream from the opening. The opening may be arranged in a housing, such as in the floor of the straw chopper.

Thus, in one or some embodiments, the disclosed method and apparatus reduce or eliminate the risk that the residual components emitted by the chaff spreader cannot enter the power spreader to then be discharged by the power spreader on the particular field.

In one or some embodiments, the straw chopper and the power spreader are coupled to each other and form a common assembly. In this regard, conveyance of the residual components and the residual flow from the transfer region into the material inlet region of the power spreader may be easier. Moreover, the combination of both units into an assembly enables an embodiment in which the power spreader is not mounted separately on a frame of the combine, but rather by a connection to the straw chopper on the combine.

The combine according to one or some embodiments includes an ejection channel of the chaff spreader that is oriented obliquely upward relative to a horizontal. In one or some embodiments, the angle is between 5° and 45°, more specifically between 10° and 40°, relative to the horizontal. Using this orientation of the ejection channel, the residual components ejected by the chaff distributor may be directed obliquely upward and therefore very easily upstream from the power spreader so that they can hence be very easily emitted upstream from the power spreader into the transfer region.

To the extent that the residual components are emitted through an opening in the floor of the straw chopper into the transfer region, it may be advantageous if the opening is located upstream from the chopper unit of the straw chopper. This arrangement of the opening has the advantage that the chopping unit does not have to additionally process the residual components, which is typically unnecessary given the already small particle size of the residual components.

In one or some embodiments, the arrangement of the opening in the floor of the straw chopper also offers the advantage that the residual components may be introduced at a lowest point of the straw chopper into the transfer region so that they can be emitted obliquely upward at a comparatively flat angle.

In one or some embodiments, a guide element is arranged or positioned at the opening that extends from a front edge of the opening. The guide element, which may be formed by a guide plate, may be designed oblique in comparison to an opening plane of the opening. The “front edge” identifies or is designated as the edge of the opening that, viewed in the delivery direction of the residual flow, is first reached by the residual flow as the residual flow is flowing along the opening. The guide element therefore has the technical effect that at least part of the residual flow guided along the opening can be guided away from the opening using the guide element. This may generate an entry volume that is at least partly (e.g., at least substantially) free of the residual flow and is therefore available to the residual components which enter through the opening into the transfer region.

Furthermore, in one or some embodiments, another guide element at the opening is contemplated which has an incline directed away from the transfer region and may be located on a rear edge of the opening. Using such a guide element, the residual components that are generally guided freely between an ejection channel of the chaff spreader and the opening (e.g., move freely through an unmodified space) are guided into the opening. This may facilitate the transfer of the residual components into the transfer region.

Moreover, in one or some embodiments, a housing of the power spreader may at least partly (or completely) house an interior of the power spreader, such as the front region of the power spreader, so that the residual components conveyed by the chaff spreader cannot directly enter the power spreader. The “front region” may be identified or designated as the region of the power spreader that lies to the front in the driving direction of the combine. The advantage of designing the housing of the power spreader in the described matter is the ability to prevent an unintentional exit of parts of the mixed flow received by the power spreader at a front end of the power spreader. This is unlike the prior art since in the prior art, the housing of the power spreader is in principle open in the front region so that the residual components can enter.

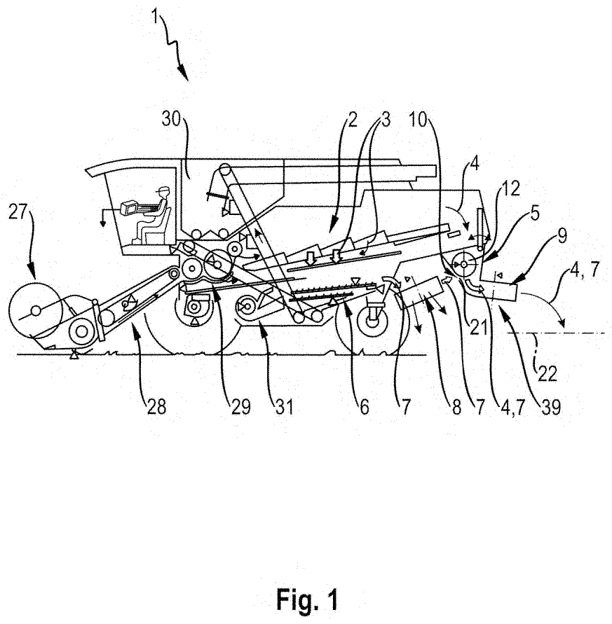

Referring to the figures, FIG. 1 illustrates a combine 1 according to one embodiment. Combine 1 is suitable for or configured for harvesting plants in the field and processing the plants so that a part of the plants (such as the fruit of the plants) is separated from the plant residues and collected. The term “fruit” is a designation of the part of the plant that is desired, with one example being grain. Other terms are contemplated. In this regard, any discussion regarding “fruit” is deemed the part of the plant that is sought to be harvested. The plant residues may be deposited at the rear end of the combine 1 or may be discarded. To this end, the combine 1 includes a cutting device 27 at its front end by which the plants can be cut. The cut plants may then be fed by an inclined conveyor 28 to a threshing device 29 through which a part of the plant, such as the fruit, may be removed from the plant residues. In particular, a majority of the fruit may be directly removed from the threshing device 29 through its threshing concave. Beginning from the threshing device 29, remaining fruit may be fed along with the plant residues separated therefrom to a downstream separating device 2 that, in the illustrated example, comprises a straw walker. Using the separating device 2, the remaining fruit may be separated from the plant residues as much as possible so that a so-called “residual grain portion” that is ejected together with the plant residues at the rear end of the combine 1 is minimal. The separating device 2 may accordingly be configured to separate a flow of material 3 (which may primarily be formed by the fruit) from the flow of material received from the threshing device 29, thereby removing and separating the flow of material 3 from a remaining residual flow 4 primarily formed by plant residues. In this regard, the separating device 2 may receive as input the flow from the threshing device 29, and may separate this flow from the threshing device 29 into at least two subparts, with a first subpart comprising the flow of material 3 (primarily formed by the fruit) and a second subpart comprising the residual flow 4. Proceeding from the separating device 2, the flow of material 3 in the illustrated example is guided downward and fed to a cleaning device 6. The cleaning device 6 is configured to remove residual components 7 in the flow of material 3 that, due to their size, were separated together with the fruit from the overall material flow. To this end, the cleaning device 6 interacts with a fan 31 that separates the (comparatively light) residual components 7 from the (comparatively heavy) fruit according to the principle of air separation, and transports the residual components 7 to a rear end of the cleaning device 6 at which the residual components 7 are transferred to a downstream chaff conveying device, such as chaff spreader 8. Thus, the chaff conveying device may comprise any one or more types of devices configured to convey the residual components, such as configured to spread or blow. Further, the fruit, which is separated by the cleaning device 6, may be conveyed to a grain tank 30 and collected there.

Both the residual components 7 (separated using the cleaning device 6) as well as the plant residues (separated using the separating device 2 that form the residual flow 4) may then be ejected from the combine 1. In one or some embodiments, discharging is more homogeneous (such as homogeneous as possible) and distributed over a working width of the combine 1 so that the nutrients contained in the plant residues may be disbursed as evenly as possible to the ground. The residual components 7 and the residual flow 4 may finally be discharged together using a power spreader 9. In one or some embodiments, power spreader 9 includes two ejection units 40, as shown in the figures.

In one or some embodiments, ejection units 40 may each have, for example, a plurality of delivery blades 32 that are arranged or positioned together on a shaft. The shaft may be rotatably drivable about an axis of rotation 33 via a motor (not shown). The delivery blades 32 may capture, accelerate, and finally eject the residual flow 4 and the residual components 7 from the combine 1. Before the residual flow 4 is fed to the power spreader 9, the residual flow 4 may first be processed using a straw chopper 5 downstream from the separating device 2. Straw chopper 5 may include a chopping unit 12, which has a rotatably drivable shaft (driven by a motor, not shown) with cleats arranged thereupon. The residual flow 4 may be fed to the straw chopper 5 such that the residual flow 4 enters an active region of the chopping unit 12 at which it is chopped with the chopping unit 12. Proceeding from the straw chopper 5, the processed residual flow 4 may then be fed to the power spreader 9.

In the illustrated example, the power spreader 9 is arranged or positioned relative to the straw chopper 5 so that the power spreader is not in line with the straw chopper. As one example, the power spreader 9 may be arranged or positioned on the bottom side of the straw chopper 5. In one or some embodiments, the straw chopper 5 is combined together with the power spreader 9 into an assembly 39. Assembly 39 has a housing 11 that includes an opening 10 through which the residual components 7 emitted by the chaff spreader 8 may enter into a transfer region 21. As shown, transfer region may include a border into which the residual components 7 may enter or pass at an entrance to the transfer region, at which residual flow 4 may enter, be adjacent or be proximate to. Initially, starting from the cleaning device 6, the residual components 7 are first received by the chaff spreader 8. As described, this is formed by one or a plurality of throw blowers, such as two throw blowers, by which the residual components 7 are blown out in a direction accelerated from a respective ejection channel 18. At least a part of the chaff spreader 8 (e.g., the ejection channels 18) in the shown example are oriented obliquely upward relative to a horizontal 22, wherein an angle between a delivery direction 24 of the residual components 7 and the horizontal 22 is approximately 25° in this case (e.g., at least 20°). The chaff spreader 8 may be oriented such that it more or less “targets” the opening 10 so that the residual components 7 are “shot” or directed into the opening 10 and therefore into the transfer region 21, wherein the ejection channels 18 of both throw blowers of the chaff spreader 8 are directed toward the same opening 10.

The residual components 7 therefore may come into contact with the residual flow 4 already processed using the straw chopper 5 upstream from a material inlet region 38 of the power spreader 9 and may be mixed there with the latter. The residual components 7 may therefore be fed to the residual flow 4 upstream from the power spreader 9. Consequently, the residual components 7 may be fed to the material inlet region 38 of the power spreader 9 together with the residual flow 4. Since in one embodiment the power spreader 9 is assigned to a bottom side of the straw chopper 5, the residual flow 4 and the residual components 7 are transferred to the material inlet region 38 of the power spreader 9 directly and jointly in a delivery direction 23 directed obliquely downward (e.g., at an angle that is less than horizontal). Accordingly, viewed from the power spreader 9, the residual flow 4 and the residual components 7 are received by the power spreader 9 “obliquely from above”. In particular, the reception of the residual flow 4 and the residual components 7 does not occur “from the rear” as may be done in previous systems. Using the power spreader 9, the residual flow 4 and the residual components 7 are ultimately ejected at the rear end of the combine 1.

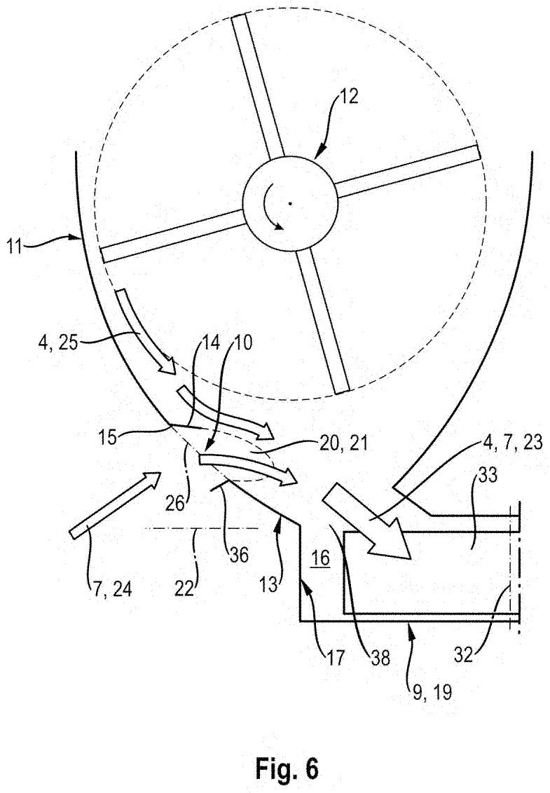

In the illustrated example, the opening 10 is located in a floor 13 of the housing 11, wherein the floor 13 in this case is arranged or positioned at a bottom end of the straw chopper 5 upstream from the chopping unit 12. At a front edge 15 of the opening 10, viewed in the flow direction 25 of the residual flow 4, the front edge 15 interacts with the guide element 14 that is formed in this case by a guide plate. In one or some embodiments, the guide element 14 extends at least partly over the width of the front edge 15. More particularly, the guide element 14 may extend over the entire width of the front edge 15 and may be oblique relative to an opening plane 26 of the opening 10. As is shown, particularly with reference to FIG. 6, the guide element 14 causes a local deflection of the residual flow 4 in the region of the opening 10. This deflection has the effect of creating an entry volume 20 in the transfer region 21 into which the residual components 7 can enter. The entry volume 20 is schematically illustrated in FIG. 6 by a dashed line.

Furthermore, the opening 10 may interact with a second guide element 36 that extends from a rear edge 37 of the opening 10. The guide element 36 may likewise be angled relative to the opening plane 26 of the opening 10, however in the opposite direction from the above-described guide element 14. In particular, guide element 14 is generally oriented inward in a direction of flow (projecting in from opening 10), whereas guide element 36 is generally oriented outward in the direction of flow (projecting out from opening 10). The guide element 36 may therefore extend in a direction facing away from the transfer region 21. Guide element 36 may thereby facilitate the entry of the residual components 7 transferred by the chaff spreader 8 that are directed to the opening 10.

Following the entry of the residual components 7 into the transfer region 21, the residual flow 4 and the residual components 7 are present in a mixed form. The residual flow 4 and the residual components 7 may flow in this form in a delivery direction 23 that is at least substantially oriented parallel to a delivery direction 25 of the residual flow 4 that the latter possessed before entering into the transfer region 21. The delivery direction 24 of the residual components 7 that they had before entering the transfer region 21 contrastingly does not have any influence on the delivery direction 23 of the mixture comprising (or consisting of) the residual flow 4 and residual components 7. The residual components 7 are therefore deflected while being added to the residual flow 4 and are to some extent assimilated by the residual flow 4, whereas the delivery direction 25 of the residual flow 4 remains more or less unchanged. In other words, the direction of the residual flow 4 before mixing (e.g., at exit of the chopping unit) and after mixing with the residual components is generally the same (e.g., less than 30°, less than 25°, less than 20°, less than 15°, less than 10°, less than 5°), whereas the direction of the residual components 7 before and after mixing changes (e.g., by at least 45°, by at least 50°, by at least 60°, by at least 70°, by at least 80°). Thus, when mixing, the amount of deflection of the residual components 7 is greater than the amount of deflection of the residual flow 4.

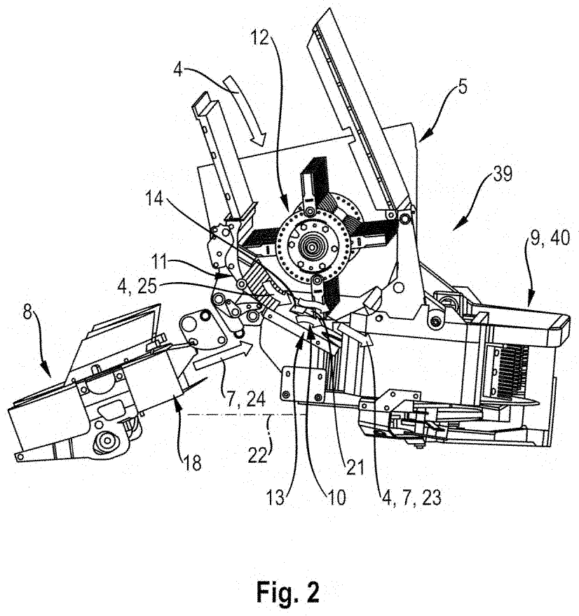

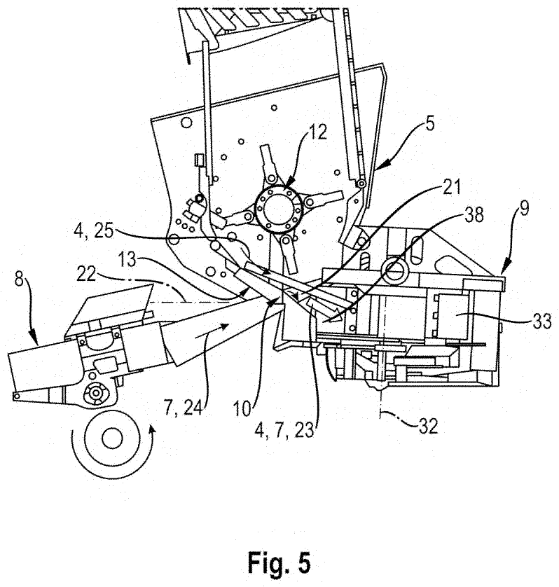

As explained above, the delivery direction 23 of the residual flow 4 and residual components 7 may be oriented obliquely downward, wherein in one embodiment the delivery direction 23 is angled approximately 35° downward (e.g., at least 20°, at least 25°, at least 30°) relative to the horizontal 22 in the shown example. This design in combination with the arrangement of the power spreader 9 at the bottom side of the straw chopper 5 allows the residual flow 4 and residual components 7 to be fed from the top side of the power spreader 9. This has the particular advantage that the housing 19 of the power spreader 9 that spatially encloses an interior 16 of the power spreader 9 is enclosed at its front region 17 viewed in the driving direction of the combine 1. This may prevent an unintentional exit of parts of the residual flow 4 or the residual components 7 at a front end of the power spreader 9. Instead, the residual flow 4 and the residual components 7 may completely enter other than at the front end (e.g., at a rear end and/or at a top end) of the power spreader 9 in a desired manner. Further, as shown in FIGS. 2, 5, and 6, residual components 7 are in at least a partly opposite direction before mixing with residual flow 4 and/or after mixing with residual flow 4 and introduction into power spreader 9. For example, residual components 7 is directed at least partly directed upward (relative to the ground) before introduction to opening 10, whereas after mixing with residual flow 4, the combination of residual flow 4 and residual components 7 are directed at least partly directed downward (relative to the ground). Alternatively, or in addition, the combination of residual flow 4 and residual components 7 are introduced into power spreader at least partly directed downward (relative to the ground). Further, the general direction of only one of the parts of the combination (such as only one of the residual flow 4 or the residual components 7) is substantially in the same direction as the direction of introduction of the combination of residual flow 4 and residual components 7 as introduced into power spreader, whereas the other of the parts of the combination is not substantially in the same direction of introduction of the combination of residual flow 4 and residual components 7 as introduced into power spreader. In particular, as shown, the residual flow 4 just prior to combination is generally downward (substantially the same as the direction of the combination of residual flow 4 and residual components 7 into power spreader) whereas the residual components 7 just prior to combination is generally not downward (e.g., generally upward).

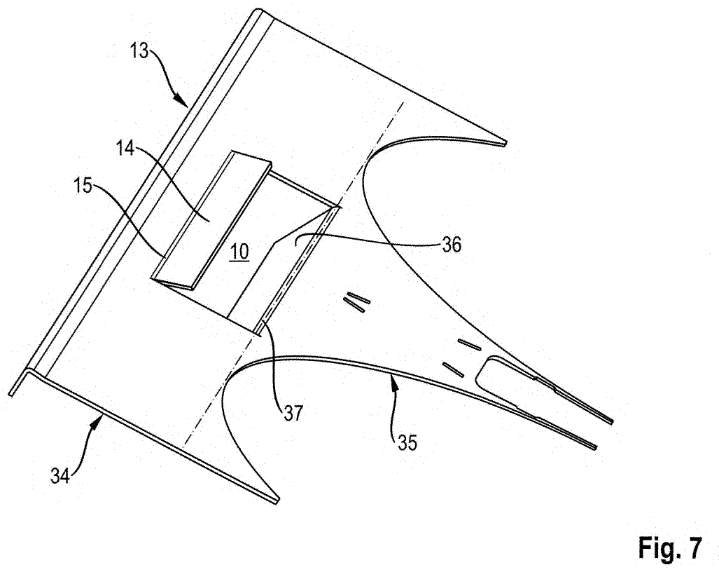

In the shown example, the floor 13 of the housing 11 comprises a full section 34 as well as a tapering section 35 adjoining the edge thereof. This is evident in FIG. 7. The opening 10 may be arranged or positioned in the full section 34. The tapering section 35 has a plurality of recesses, such as two parabolic recesses that are formed to complement the housings 19 of the ejection units 40 of the power spreader 9. The floor 13 is consequently suitable to extend in the direction of the power spreader 9 up to between the ejection units 40 and thereby enable a direct transfer of the already mixed residual flow 4 and residual components 7 to the power spreader 9.

It is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another.

### LIST OF REFERENCE NUMBERS

1 Combine

2 Separating device

3 Flow of material

4 Residual flow

5 Straw chopper

6 Cleaning device

7 Residual component

8 Chaff spreader

9 Power spreader

10 Opening

11 Housing

12 Chopping unit

13 Floor

14 Guide element

15 Edge

16 Interior

17 Region

18 Ejection channel

19 Housing

20 Entry volume

21 Transfer region

22 Horizontal

23 Delivery direction

24 Delivery direction

25 Delivery direction

26 Opening plane

27 Cutting device

28 Inclined conveyor

29 Threshing device

30 Grain tank

31 Fan

32 Rotational axis

33 Delivery blades

34 Full section

35 Tapering section

36 Guide element

37 Edge

38 Material entry region

39 Assembly

40 Ejection unit

1. A method for operating a self-propelling combine, the method comprising:
separating a flow into a flow of material and a residual flow, wherein the residual flow comprises more of plant residues than in the flow of material;
processing, using a straw chopper, the residual flow;
cleaning, using a cleaning device, the flow of material in order to separate residual components from the flow of material;
emitting the residual components from the cleaning device into a transfer region of the straw chopper;
merging, upstream of a power spreader and in the straw chopper, the residual flow and the residual components;
conveying the merged residual flow and residual components to a material inlet region of the power spreader; and
ejecting the merged residual flow and residual components using the power spreader.

2. The method of claim 1, wherein the residual components enter through an opening in a floor of the straw chopper into the transfer region of the straw chopper and are mixed with the residual flow in order to merge the residual components with the residual flow.

3. The method of claim 2, wherein conveying the residual components to the transfer region of the straw chopper comprises using one or more throw blowers in order to emit the residual components into the transfer region through the opening in the floor of the straw chopper.

4. The method of claim 3, wherein the residual flow is deflected in the transfer region such that an entry volume is formed in the transfer region into which the residual components enter.

5. The method of claim 4, wherein the residual flow is deflected using a guide element.

6. The method of claim 1, wherein the residual flow and the residual components merge within the cleaning device prior to introduction to the power spreader; and
wherein the merged residual flow and residual components are introduced to the power spreader in an at least partly downward direction relative to ground.

7. The method of claim 6, wherein the merged residual flow and residual components are introduced to the power spreader at an angle of at least 15° relative to horizontal.

8. The method of claim 6, wherein at least one of the residual flow or the residual components are in a partly downward direction relative to horizontal at or proximate to the transfer region; and
wherein another of the at least one of the residual flow or the residual components are not in a downward direction at all relative to horizontal at an entrance to the transfer region.

9. The method of claim 8, wherein the residual flow is in the partly downward direction relative to horizontal proximate to the transfer region; and
wherein the residual components are in an upward direction relative to horizontal at the entrance to the transfer region.

10. The method of claim 9, wherein the residual components are at least 10° relative to horizontal at the entrance to the transfer region.

11. A self-propelling combine comprising:
a cleaning device configured to clean a flow of material comprising grains and residual components;
a chaff spreader configured to receive the flow of material from the cleaning device and to separate the residual components from the grains;
a straw chopper configured to process a residual flow formed by plant residues, to receive the residual components from the chaff spreader into a transfer region, and to merge the residual flow and the residual components received from the chaff spreader; and
a power spreader, the power spreader including a material inlet region into which the merged residual flow and the residual components are transferred from the straw chopper, the power spreader configured to eject the merged residual flow and the residual components from the combine.

12. The combine of claim 11, wherein the straw chopper includes a bottom in its housing through which the merged residual flow and the residual components are transferred to the material inlet region of the power spreader.

13. The combine of claim 12, wherein the straw chopper and the power spreader are coupled to each other and form a common assembly.

14. The combine of claim 12, wherein the chaff spreader includes an ejection channel oriented obliquely upward relative to a horizontal through which the residual components are transferred to the straw chopper.

15. The combine of claim 14, wherein the ejection channel is oriented obliquely upward to at least 10° and to no more than 40°.

16. The combine of claim 14, wherein the straw chopper comprises at least one opening arranged in a housing of the straw chopper downstream from a chopping unit of the straw chopper through which the residual components transmitted from the chaff spreader are emitted into the transfer region.

17. The combine of claim 16, further comprising a guide element arranged at the at least one opening; and
wherein the guide element, viewed in a delivery direction of the residual flow, extends obliquely relative to an opening plane of the opening starting from a front edge of the opening so that at least part of the residual flow guided along the opening is deflected using the guide element and is thereby guided away from the at least one opening.

18. The combine of claim 17, wherein the guide element comprises a first guide element;
further comprising a second guide element extending from a rear edge of the at least one opening; and
wherein the second guide element is angle in an opposite direction from the first guide element.

19. The combine of claim 11, wherein a housing of the power spreader houses an interior of the power spreader such that the residual components from the chaff spreader only enter the power spreader via the straw chopper and not directly from the chaff spreader to the power spreader.

20. The combine of claim 11, wherein the power spreader is positioned on a bottom side of the straw chopper; and
wherein the merged residual flow and residual components are transferred to the material inlet region in a direction obliquely downward.
